(19) United States
(12) Patent Application Publication
(10) Pub. No.: US 2011/0147108 A1
(43) Pub. Date: Jun. 23, 2011

(54) Four Wheel Drive, Zero Turn Radius Mower

(76) Inventors: Michael Rudolf Hecht, SR., Westminster, MD (US); Arthur Leon Evans, Coatsville, IN (US)

(21) Appl. No.: 12/971,074

(22) Filed: Dec. 17, 2010

Related U.S. Application Data
(60) Provisional application No. 61/287,240, filed on Dec. 17, 2009.

(51) Int. Cl. B60K 17/34; B60K 17/30; B23P 17/04

(52) U.S. Cl. 180/233; 280/99; 29/428

(57) ABSTRACT

A mower apparatus and method for making the same is provided. A mower apparatus may include a multi-wheel drive mower system having at least one mower blade and at least one front wheel positioned proximate the front of the mower system and at least one rear wheel positioned proximate the rear of the mower system. The mower apparatus may also include a zero turn assembly haying at least one caster wheel. The zero turn assembly may be rotatably attached to the multi-wheel drive mower system to provide the mower apparatus with the capability of operating in either a multi-wheel drive mode having at least the at least one front wheel and the at least one rear wheel engaging the ground or a zero turn radius mode having only the at least one caster wheel and the at least one rear wheel engaging the ground.

### CROSS REFERENCE TO RELATED APPLICATION

This application claims the benefit of and incorporates by reference herein the disclosure of U.S. Ser. No. 61/287,240, filed Dec. 17, 2009.

### BACKGROUND

Zero turn radius lawn mowers are common in the lawn mowing industry and are generally regarded as the standard when it comes to maneuverability. One drawback with the zero turn radius lawn mower is its reduced ability to hold a hillside when mowing. The reason for this short coming is that such zero turn radius mowers have just two drive wheels located at the rear of the machine and two front wheels set on casters. Because the caster wheels spin freely and don't have their own power, the zero turn radius mowers tend to “steer” down a slope and have some difficulty negotiating steep and/or wet terrain. When an operator of a zero turn radius mower attempts to negotiate steep and/or wet terrain, the rear drive wheels may tear through the turf as they spin in place. Homeowners and commercial grass cutters have been forced to trim such areas with other cutting equipment thus decreasing their efficiency in performing their job.

Accordingly, there exists a need for a system that can allow mower operators to mow with great maneuverability and safely on uneven and/or wet terrain.

### SUMMARY

The present disclosure discloses a mower apparatus and method for making the same. One embodiment of a mower apparatus includes a multi-wheel drive mower system having at least one mower blade and at least one front wheel positioned proximate the front of the mower system and at least one rear wheel positioned proximate the rear of the mower system. The mower apparatus also includes a zero turn assembly having at least one caster wheel. The zero turn assembly is rotatably attached to the multi-wheel drive mower system to provide the mower apparatus with the capability of operating in either a multi-wheel drive mode having at least the at least one front wheel and the at least one rear wheel engaging the ground or a zero turn radius mode having only the at least one caster wheel and the at least one rear wheel engaging the ground.

One embodiment of a mower includes at least one mower blade, drive wheels and an engine. The mower also includes at least one front wheel positioned relatively closer to a front end of the mower than the drive wheels and at least one zero-turn wheel positioned relatively closer to the front of the mower than the drive wheels. The mower is adjustable between a first position in which the at least one front wheel engages the ground and the at least one zero-turn wheel is disengaged from the ground, and a second position in which the at least one zero-turn wheel engages the ground and the at least one front wheel is disengaged from the ground.

One embodiment of a method of assembling a mower apparatus includes providing a four wheel drive mower system having at least one mower blade and a first pair of wheels positioned near the front of the mower system and a second pair of wheels positioned near the rear of the mower system and a zero turn assembly having a plurality of caster wheels. The method of assembling also includes attaching the zero turn assembly to the four wheel drive mower system such that the zero turn assembly is capable of rotating relative to the four wheel drive mower system to provide the mower apparatus with the capability of operating in either a four wheel drive mode having at least the first and second pair of wheels engaging the ground or a zero turn radius mode having only the plurality of caster wheels and second pair of wheels engaging the ground.

### BRIEF DESCRIPTION OF THE DRAWINGS

The features and advantages of this disclosure, and the manner of attaining them, will be more apparent and better understood by reference to the following descriptions of the disclosed method and computer-readable program, taken in conjunction with the accompanying drawings, wherein:

FIG. 1 shows a mower apparatus according to at least one embodiment of the present disclosure.

FIG. 2 shows a frame and transmission frame assembly attached together according to at least one embodiment the present disclosure.

FIG. 3 shows an exploded view of a steering mechanism and transmission frame assembly according to at least one embodiment of the present disclosure.

FIG. 4 shows a top view of the zero turn assembly shown in FIG. 1.

FIG. 5 shows a perspective view of the zero turn assembly shown in FIG. 1.

FIG. 6 shows the mower apparatus shown in FIG. 1 in zero turn radius mode.

FIG. 7 shows the mower apparatus shown in FIG. 1 in four wheel drive mode.

FIG. 8 shows the mower apparatus shown in FIG. 1 shows the deck changing in height as the zero turn assembly converts the apparatus from a four wheel drive mode to a zero turn mode.

FIG. 9 shows various deck components assembled according to at least one embodiment of the present disclosure.

FIG. 10 shows an oil accumulator attached to the engine of a mower apparatus according to at least one embodiment of the present disclosure.

### DETAILED DESCRIPTION

For the purposes of promoting an understanding of the principles of the present disclosure, reference will now be directed to the embodiments illustrated in the drawings, and specific language will be used to describe the same. It should be noted that no limitation of the scope of this disclosure is thereby intended.

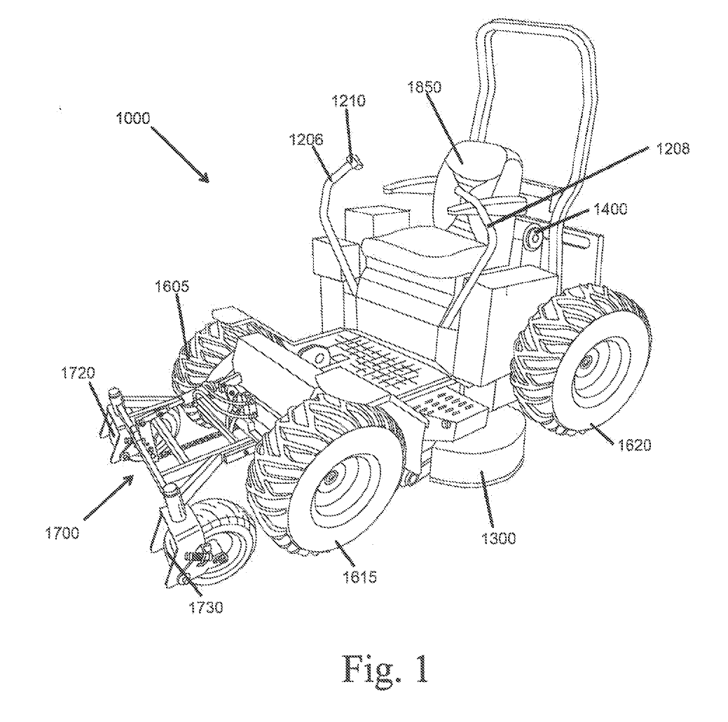

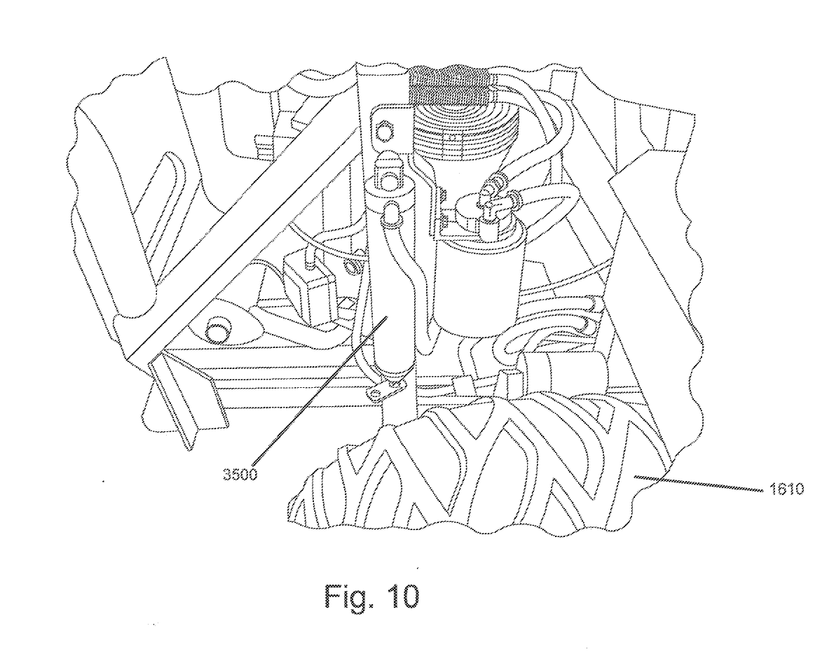

The present disclosure provides a mower apparatus and a method for manufacture of the same. FIG. 1 shows a perspective view of a mower apparatus 1000 according to one embodiment of the present disclosure. As shown in FIG. 1, mower apparatus 1000 includes right and left steering levers or handles 1206, 1208 for maneuvering the mower apparatus 1000, a seat 1850, a deck portion 1300 including one or more blades 1305 (not shown), front right wheel 1605 and front left wheel 1615, rear right wheel 1610 (shown in FIG. 10) and rear left wheel 1620, a zero turn assembly 1700 including caster wheels 1720, 1730, and an engine 1400 for providing power to the mower apparatus 1000 and performing such functions as operating the blades 1305, front right wheel 1605 and front left wheel 1615, rear right wheel 1610 and rear left wheel 1620 and operating the zero turn assembly 1700 to provide the mower apparatus 1000 with the ability to alternate between four wheel drive and zero turn radius movement.

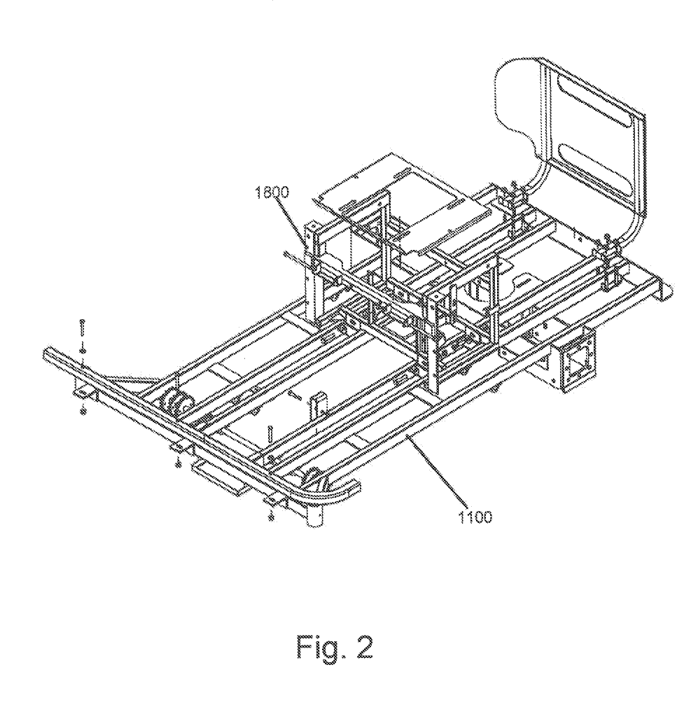

FIG. 2 shows a frame 1100 and a transmission frame assembly 1800 that may be included in the mower apparatus 1000. The frame 1100 and transmission frame assembly 1800 may be used for connecting and supporting various components of the mower apparatus 1000. For example, the deck portion 1300, engine 1400, and zero turn assembly 1700 may all be connected to the frame 1100. The front and rear wheels 1605,1615,1610,1620 may also be connected and supported by the frame 1100. The frame 1100 may be various shapes including, but not limited to, an H-shape, an I-shape, rectangular-shape, and square shape. The frame 1100 may be various sizes. It should be noted that the size of the engine 1400 typically influences the size of the frame 1100. The frame 1100 may be formed of tubular or solid bars of steel; however other metals and configurations may be used.

The transmission frame assembly 1800 may serve as a means for mounting components of the mower apparatus 1000 to the mower frame 1100. Such components may include, but are not limited to, a steering mechanism 1200 (described below), T gear box, left steering pump, right steering pump, and seat 1850 and corresponding seat pan. The transmission frame assembly 1800 may include vertical and horizontal metal (e.g., steel) bars or tubing that are located beneath the seat 1850 and corresponding seat pan. The transmission frame assembly 1800 may be connected to the frame 1100 by various means, such as, for example, four bolts (as illustratively shown in FIG. 2) or using welds. The transmission frame assembly 1800 may be various shapes, including, but not limited to, rectangle, square, or tubular in shape. The transmission frame assembly 1800 may be formed of various materials, including, but not limited to, steel, aluminum, and composites.

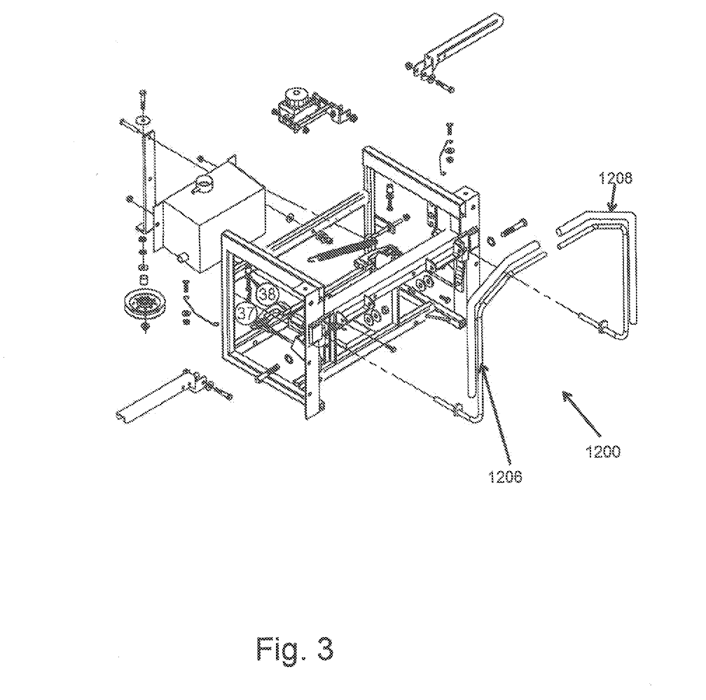

As shown in FIG. 3, right and left steering handles 1206, 1208 are components of the steering lever mechanism 1200. The steering lever mechanism 1200 may be attached to the transmission frame assembly 1800 in various ways, including, but not limited to, bolts and welds. The steering lever mechanism 1200, and consequently the mower apparatus 1000, can be manipulated by moving handles 1206, 1208 forward and backward. For example, by moving the levers 1206, 1208 forward in tandem, the mower apparatus 1000 may move forward. By moving the levers 1206, 1208 backward in tandem, the mower apparatus 1000 may move backward. Either lever may be moved forward or backward independently to effectuate a turn. Illustratively, the degree at which each lever is independently moved will directly impact the speed at which the associated wheel is driven, and hence the speed at which the mower apparatus 1000 turns.

The operation of the steering lever mechanism 1200 in the mower apparatus 1000 may be accomplished in a variety of ways. In one example, both steering levers 1206, 1208 may be connected to a steering block. Upon manipulation by an operator of the mower apparatus 1000 using the levers 1206, 1208, the steering block manipulates (via a mechanical means) a linkage rod that is attached to a hydraulic pump arm. Depending on the position of the steering levers 1206, 1208, the hydraulic pump arm moves forward or backward. The movement of the hydraulic pump arm causes hydraulic fluid to move to a wheel motor via hydraulic lines. As a result, the wheel motor activates the respective drive wheels 1605, 1610, 1615, 1620 as seen in FIG. 1.

The wheels 1605, 1610, 1615, 1620 of the mower apparatus 1000 may be formed of any type of material and may vary in size. For example, one or more of the wheels 1605, 1610, 1615, 1620 may be formed of rubber or plastic and having the following dimensions: 27 inches high×13 inches wide×12 inches inside tire diameter. In the illustrated embodiments, the front wheels 1605, 1615 and rear wheels 1610, 1620 are powered; however, it is within the scope of this disclosure for the front wheels 1605,1615 to be temporarily or permanently unpowered but fixed or partially fixed to prevent undesired turning movement of the wheels. Also, in the illustrated embodiments, the mower apparatus 1000 includes two front wheels 1605, 1615 and two rear wheels 1610, 1620; however, it is within the scope of this disclosure for there to be only one or more than two front wheels or only one or more than two rear wheels.

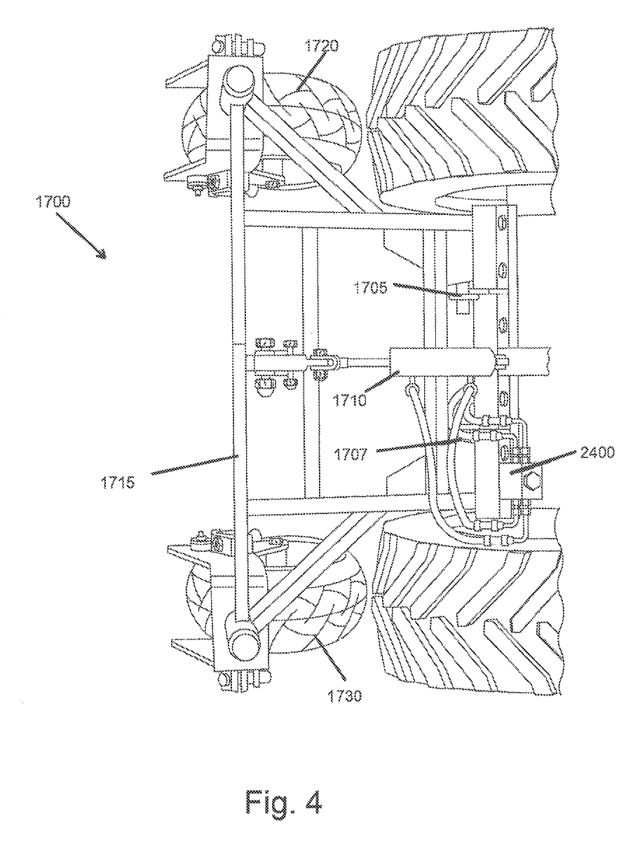

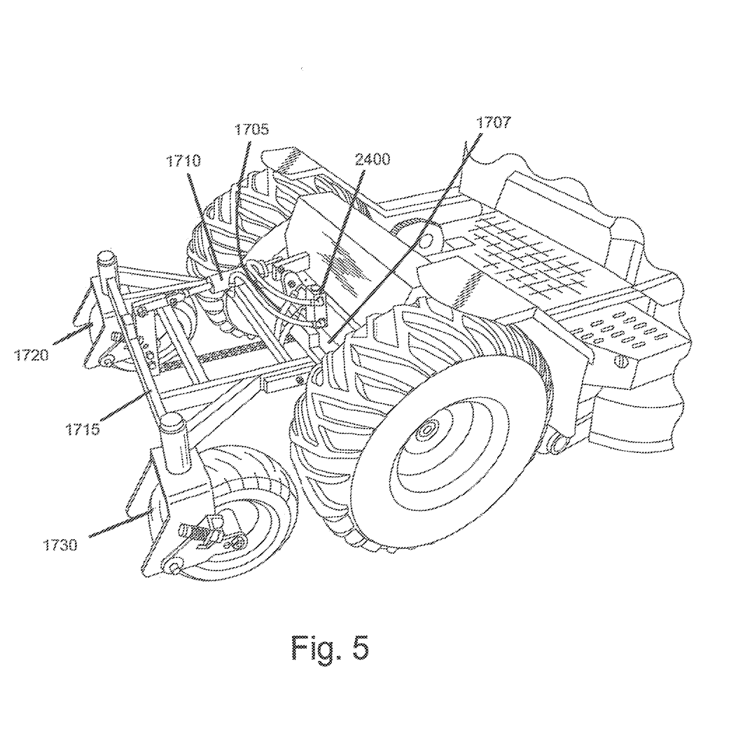

As mentioned above and shown in FIG. 1, mower apparatus 1000 includes a zero turn assembly (or ZTA) 1700. The ZTA 1700 provides the mower apparatus 1000 with the capability of being operated in either zero turn radius style mowing or multi-wheel drive mowing. As shown in FIGS. 1, 4, and 5, the ZTA 1700 includes two caster wheels 1720, 1730 and a hydraulic actuator cylinder 1710. In FIGS. 1, 4, and 5, the ZTA 1700 also includes a framework 1715 that connects the caster wheels 1720, 1730 to the frame 1100 or other portion of the mower apparatus 1000 such that the ZTA 1700 is able to rotate relative to the other components of the mower apparatus 1000 (e.g., frame 1100). As shown in FIG. 4, the ZTA 1700 may be attached to the frame 1100 using two hinges 1705, 1707. The hydraulic actuator cylinder 1710 itself may be attached to the frame using a bolt and a clevis pin. In FIG. 4, the ZTA 1700 is able to rotate about the hinges 1705, 1707 and, therefore, about the frame 1100. While FIG. 4 shows the use of a hydraulic actuator cylinder 1710, it should be noted that the ZTA 1700 may be rotated relative to the other components of the mower apparatus 1000 using various other mechanisms.

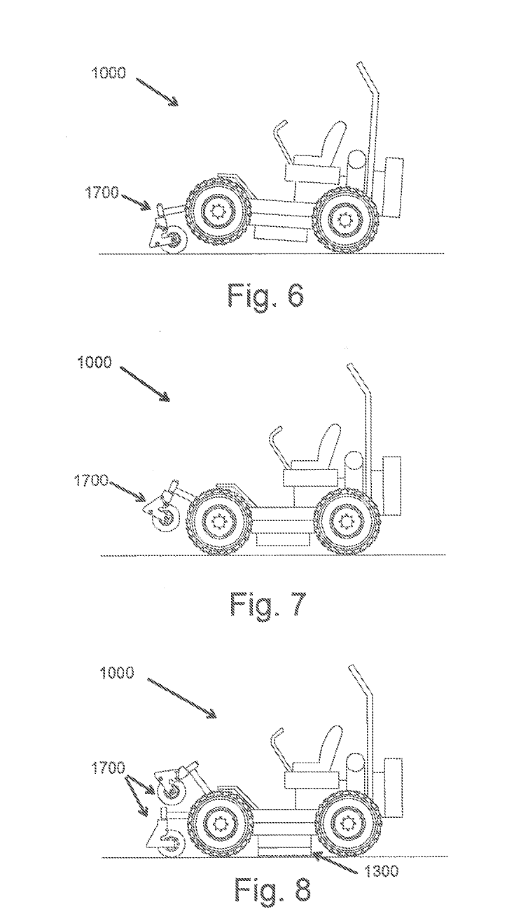

FIG. 6 shows the mower apparatus 1000 in the zero turn radius configuration. As shown in FIG. 6, the ZTA 1700 has been actuated such that the caster wheels 1720, 1730 come into contact with the ground, resulting in the two front wheels 1605, 1615 of the mower apparatus 1000 suspended above the ground. When the two front wheels 1605, 1615 are suspended above the ground, the mower apparatus 1000 is capable of operating like a zero turn radius mower. As shown in FIG. 7, the ZTA 1700 may be actuated such that the two caster wheels 1720, 1730 are suspended above the ground, resulting in the two front wheels 1605, 1615 being in contact with the ground. When the two front wheels 1605 and 1615 are in contact with the ground, the mower apparatus 1000 is capable of operating in four wheel drive.

In order to adjust the mower apparatus 1000 such that it can operate in either zero turn radius or four wheel drive mode, the operator may manipulate an electric switch 1210 (shown in FIG. 1) which sends an electric signal to a solenoid operated valve. By pressing the switch 1210, the operator manipulates the solenoid operated valve which in turn causes hydraulic fluid to be funneled to the hydraulic actuator cylinder 1710 through a two-way check valve 2400. As shown in FIG. 4, there are two hydraulic lines that run from the check valve 2400 to the hydraulic cylinder 1710. Depending on how the hydraulic actuator cylinder 1710 is actuated, the ZTA 1700 rotates either upwards or downwards.

While the mower apparatus 1000 is illustratively depicted as having an electric switch 1210, it should be noted that any type or kind of switching may be used. For example, the switching may be carried out manually, electronically, or hydraulically. In addition, it should be noted that the hydraulic piston described herein may be replaced or complemented with any other kind of actuator that allows the ZTA 1700 to move or rotate relative to the frame 1100 or other portion of the mower apparatus 1000.

As shown in FIG. 1, the electronic switch 1210 may be located on either steering handle 1206, 1208. Of course, the electronic switch 1210 may be located in other places and on other components. While the two-way check valve 2400 is attached to the frame 1100 adjacent to the front left wheel 1615, it may be located anywhere on the frame 1100 or other component. It should be noted that the framework 1715 of ZIA 1700 may be various shapes and sizes and formed of various materials. For example, in FIG. 4, the framework 1715 resembles the shape of a trapezoid. Alternatively, the framework 1715 may be another shape, such as, for example, a rectangle or a square. The framework 1715 may be formed of various materials, including, but not limited to, metal and composites.

The caster wheels 1720, 1730 of the ZTA 1700 may be formed of any type of material and may vary in size. For example, one or more of the wheels 1720, 1730 may be formed of rubber or plastic. While caster wheels 1720, 1730 are illustratively depicted as such that they can spin freely, it is within the scope of this disclosure for one or more caster wheels to be coupled to be steerable or otherwise moveable to accommodate a generally highly steerable or near zero-turn capability. In other words, it is within the scope of this disclosure for the caster wheels 1720, 1730 to be temporarily or permanently powered and/or temporarily or permanently steerable. Also, in the illustrated embodiments, the ZTA 1700 includes two caster wheels 1720, 1730; however, it is within the scope of this disclosure for there to be only one or more than two caster wheels.

The deck 1300 of the mower apparatus 1000 houses the blades 1310, which may be spun with the aid of a belt that is attached to the engine 1400 to cut grass and the like. It should be noted that the blades 1310 may be attached to a spindle underneath the deck 1300. According to one embodiment of the present disclosure and as exemplified in FIG. 8, the deck 1300 of the mower apparatus 1000 includes a deck leveling system that can change the height of the deck 1300 relative to the frame 1100 by manual operation or based on the orientation of the ZTA 1700. In this way, the mower apparatus 1000 may compensate for the change in height between the ground and the blades 1310 that occurs when the mower system 1000 shifts between a four wheel drive configuration to a zero turn radius configuration. As a result, the mower apparatus 1000 can continuously mow at a consistent height regardless of the terrain being negotiated.

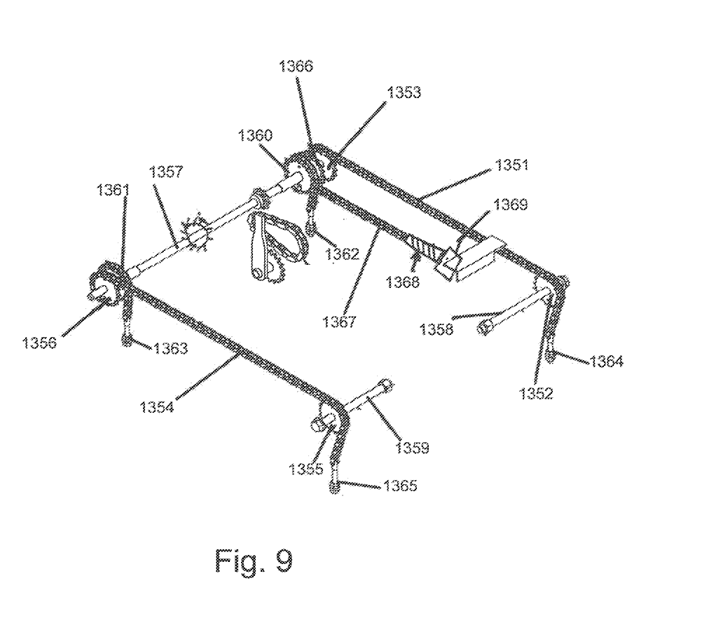

In FIG. 1, the deck 1300 is located beneath the frame 1100 itself. The deck 1300 may be connected to the frame 1100 using a variety of components. In one example, as shown in FIG. 9, the deck 1300 may be hung from the frame 1100 via four chains, where long chain 1351 is wrapped over sprockets 1352, 1353 and long chain 1354 is wrapped over sprockets 1355,1356, It should be noted that long chains 1351, 1354 may be permanently attached to sprockets 1353, 1356 via master links towards the front of the mower apparatus 1000. As shown in FIG. 9, sprockets 1353, 1356 may be welded to the deck lift cross shaft 1357, which may be held in place beneath the frame 1100 via six steel saddles that are welded to the bottom of frame 1100. The rear sprocket rotating bolt 1358, 1359 may be attached to the frame 1100 via two steel saddles that are welded to the bottom of frame 1100. As shown in FIG. 9, the rear sprocket rotating bolts 1358, 1359 may have sprockets 1352, 1355, respectively, attached to said rotating bolts 1358, 1359. The tension on chains 1351, 1354 may keep sprockets 1552, 1355 properly aligned laterally along their respective rear sprocket rotating bolts.

The right and left front short chain sprockets 1360, 1361 may be attached to deck lift cross shaft 1357 via welds but may be attached by other means, such as, for example, bolts. The front short chain sprockets 1360, 1361 may have short chains 1370, 1372 wrapped around them that are permanently connected to the sprockets 1360, 1361 themselves via a master link in the chain. The short chains 1370, 1372 may also be connected to respective deck leveling studs 1362, 1363 via master links in the chains. The deck leveling studs 1362, 1363 may pass through holes in the mower deck 1300 and may be fastened in place via a nut. In FIG. 9, there are two deck leveling studs 1364, 1365 that attach to the long chains 1351, 1354 respectively in the same manner as described above. The two deck leveling studs 1364, 1365 may be further attached to the rear of the deck in substantially the same manner as described above.

As shown in FIG. 9, the electric deck lift sprocket 1366 is attached to the right side of the deck lift cross shaft 1357. The electric deck lift sprocket 1366 may be welded to the deck lift cross shaft 1357 or attached in some other fashion, such as, for example, using fasteners. As shown in FIG. 9, the electric deck lift chain 1367 is wrapped around and secured to the sprocket 1366 via a master link. In FIG. 9, the electric deck lift chain 1367 is attached to a steel flat bar 1368 via a master link. As shown in FIG. 9, the steel flat bar 1368 may be connected to the electric actuator 1369 via a bolt and nut. The electric actuator 1369 may be controlled by the operator so as to lift and lower the mower deck 1300 at will or controlled automatically in response to the adjustment between zero turn and four wheel drive configurations. The operator may operate the electric actuator 1369 in various ways, such as, for example, using a toggle switch located on the instrument control panel.

In FIG. 1, the mower apparatus 1000 also includes an engine 1400 that provides power to the entire mower apparatus. The engine 1400 is connected to various systems via belts so as to turn the blades 1310, turn pulleys that are connected to the T gear box, and operate various components. As generally describe above, the rotation of the T gear box results in hydraulic fluid being sent to hydraulic pumps and then to the wheel motors. The engine 1400 may also be connected directly to the hydraulic pumps, thereby eliminating the need for a T gear box. The engine 1400 may be affixed to the frame 1100 in various ways, such as, for example, four bolts. The engine may be propelled by gasoline, natural gas, diesel, propane or other fuels.

As shown in FIG. 1, the mower apparatus 1000 includes a seat 1850. The seat 1850 may be supported by the frame 1100 and bolted to a seat pan, which is bolted to the transmission frame assembly 1800. Gasoline and diesel powered mower apparatus 1000 machines may include fuel tanks attached to fender assemblies, which may be coupled to the lateral sides of the transmission frame assembly 1800. For a mower apparatus 1000 powered by fuels other than gasoline, the fuel tanks may be attached directly to the transmission frame assembly 1800. It should be noted that in some instances a mower apparatus 1000 may not include a seat 1850. For example, the mower apparatus 1000 may be designed for an operator to stand while operating the apparatus 1000.

As shown in FIG. 10, the mower apparatus 1000 may optionally include an oil accumulator 3500 to aid in operating the apparatus 1000 on steeper grades. In FIG. 10, the oil accumulator 3500 is attached to the engine 1400. When the engine 1400 is started and oil pressure increases, oil pressure overcomes the spring force exerted by a spring within the accumulator 3500, causing oil to be introduced in the accumulator 3500 and displacing an internal piston of the accumulator 3500, During operation of the mower apparatus 1000, the oil accumulator 3500 essentially functions to send engine oil to the engine 1400 for continual lubrication despite the terrain the mower apparatus 1000 is traversing. As the mower apparatus 1000 ascends or descends a steep grade, gravity pulls the engine oil away from the oil pump thus reducing lubrication and placing the engine 1400 at risk of lack of lubrication. The oil accumulator 3500 forces engine oil back to the oil pump so that it can be picked up by the oil pump and circulated to lubricate the engine 1400. When the engine 1400 is stopped and oil pressure reduces, the spring tension causes the piston to force oil from the accumulator 3500 to the oil sump of the engine 1400. In one example, additional oil is added to the engine 1400 and or other components of the mower apparatus 1000 to assure adequate oil will be present in the oil sump and the accumulator 3500 to compensate when operating on a grade.

While various embodiments of a mower apparatus and method for manufacturing the same have been described in considerable detail herein, the embodiments are merely offered by way of non-limiting examples of the disclosure described herein. It will therefore be understood that various changes and modifications may be made, and equivalents may be substituted for elements thereof, without departing from the scope of the disclosure. For example, any number of components referenced herein may have one or more features/configurations of another component referenced within the present disclosure. Indeed, this disclosure is not intended to be exhaustive or to limit the scope of the disclosure.

Further, in describing representative embodiments, the disclosure may have presented a method and/or process as a particular sequence of steps. However, to the extent that the method or process does not rely on the particular order of steps set forth herein, the method or process should not be limited to the particular sequence of steps described. Other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A mower apparatus comprising:
a multi-wheel drive mower system comprising a mower blade and at least one front wheel positioned proximate the front of the mower system and at least one rear wheel positioned proximate the rear of the mower system; and
a zero turn assembly comprising at least one caster wheel, the zero turn assembly rotatably attached to the multi-wheel drive mower system to provide the mower apparatus with the capability of operating in either a multi-wheel drive mode having at least the at least one front wheel and the at least one rear wheel engaging the ground or a zero turn radius mode having only the at least one caster wheel and the at least one rear wheel engaging the ground.

2. The mower apparatus of claim 1, further comprising an engine.

3. The mower apparatus of claim 2, wherein the at least one front wheel is powered by the engine.

4. The mower apparatus of claim 3, comprising two front wheels powered by the engine.

5. The mower apparatus of claim 1, further comprising a deck coupled to the zero turn assembly, wherein the deck is movable between a first position and a second position.

6. The mower apparatus of claim 5, wherein the deck is mechanically coupled to the zero turn assembly so that, when the zero turn assembly switches between the multi-wheel drive mode and the zero turn radius mode, the deck moves between the first position and the second position.

7. A mower comprising;
at least one mower blade, drive wheels, and an engine;
at least one front wheel positioned relatively closer to a front end of the mower than the drive wheels;
at least one zero-turn wheel positioned relatively closer to the front of the mower than the drive wheels;
wherein the mower is adjustable between a first position in which the at least one front wheel engages the ground and the at least one zero-turn wheel is disengaged from the ground, and a second position in which the at least one zero-turn wheel engages the ground and the at least one front wheel is disengaged from the ground.

8. The mower of claim 7 wherein the at least one front wheel is powered by the engine.

9. The mower of claim 8 comprising two front wheels powered by the engine.

10. The mower of claim 7 further comprising a main frame to which the drive wheels, engine and mower blade are coupled, and a movable frame movably coupled to the main frame, wherein the at least one zero-turn wheel is coupled to the movable frame, and moves from an up position to a down position in which the mower is adjusted from the first position to the second position respectively.

11. The mower of claim 10 further comprising an actuator to move the movable frame between the up and down positions.

12. The mower of claim 11 further comprising a hydraulic system which actuates the actuator to move.

13. The mower of claim 10 further comprising a deck movably coupled to the main frame, and the mower blade is movably coupled to the deck, wherein the deck is movable between a first position and a second position, wherein the deck is positioned closer to the main frame in the first position.

14. The mower of claim 11 further comprising a deck movably coupled to the main frame, and the mower blade is movably coupled to the deck, wherein the deck is movable between a first position and a second position, wherein the deck is positioned closer to the main frame in the first position.

15. The mower of claim 13, wherein the deck is mechanically coupled to the actuator so that, when a user actuates the actuator, the movable frame moves between the up position and the down position, and the deck moves between the first position and second position.

16. The mower of claim 10, wherein the at least one zero-turn wheel is coupled to the movable frame with a castor.

17. The mower of claim 16 comprising two zero turn wheels coupled to the movable frame with a castor.

18. The mower of claim 17, further comprising an oil accumulator.

19. A method of assembling a mower apparatus, the method comprising:
providing a four wheel drive mower system comprising at least one mower blade and a first pair of wheels positioned proximate the front of the mower system and a second pair of wheels positioned proximate the rear of the mower system;
providing a zero turn assembly comprising a plurality of caster wheels; and
attaching the zero turn assembly to the four wheel drive mower system such that the zero turn assembly is capable of rotating relative to the four wheel drive mower system to provide the mower apparatus with the capability of operating in either a four wheel drive mode having at least the first and second pair of wheels engaging the ground or a zero turn radius mode having only the plurality of caster wheels and second pair of wheels engaging the ground.

20. The method of claim 19, wherein the mower system comprises a deck configured to be coupled to the zero turn assembly such that, when the zero turn assembly
